(19) United States
(12) Patent Application Publication
(10) Pub. No.: US 2005/0209910 A1
(43) Pub. Date: Sep. 22, 2005

(54) System, method, and computer program product for increasing the effectiveness of customer contact strategies

(75) Inventor: David A. Selby, Fareham (GB)

Correspondence Address: SYNNESTVEDT & LECHNER, LLP, 2600 ARAMARK TOWER, 1101 MARKET STREET, PHILADELPHIA, PA, 191072950, US

(73) Assignee: International Business Machines Corporation, Armonk, NY (US)

(21) Appl. No.: 10/806,204

(22) Filed: Mar. 22, 2004

(51) Int. Cl. G06F 17/60

(52) U.S. Cl. 705/10

(57) ABSTRACT

A method for selecting an optimal set of events to be performed, where each event has a value, such as an expected gain, and where the selection of any event reduces or leaves unchanged the value of unselected events. The list of events is sorted, in full, once, based on the event values and then, on the occurrence of a predetermined trigger, the first event in the list is selected. Any changes to the unselected event values are effected, and then, rather than resorting the entire list of remaining events, the highest-valued unselected event is moved to the top without having to sort the entire list. This is accomplished by performing a truncated sort that relies on the fact that all of the values in the list beneath the first value will be either reduced or remain the same, but will never get larger.

### FIELD OF THE INVENTION

The present invention relates generally to a marketing system and method, and in particular, to a system, method and computer program product for selecting an optimal set of events to be performed as part of a marketing program.

### BACKGROUND OF THE INVENTION

Direct marketing involves advertising to customers at a location other than the point of sale. Catalogs, first-class mail, telemarketing, and e-mail are some examples of direct marketing techniques that are currently utilized to promote the sale of goods or services.

Direct marketers today face challenges that are far different than those with which the industry contended during its explosive growth over the last twenty years. Among the problems of particular interest:
The percentage of households purchasing through the mail has been essentially flat since 1993.
The consumer base is becoming increasingly diverse and individualistic.
The average number of promotions received per household continues to climb.
The costs of advertising (and in particular, paper, postage and ink) has been steadily increasing and shows no sign of leveling off.
Consumers increasingly demand services such as the ability to place phone orders and expedited delivery as standard.

Increasingly, retail companies are adding direct marketing to their mix of marketing techniques. In addition, with the explosion of the internet and e-commerce, consumers are presented with increasingly attractive alternatives to mail for the direct purchase of goods and services in their homes.

In response to these changes, direct marketers have responded in a variety of ways. Many direct marketers have improved their targeting of recipients of direct marketing through automation. For example, automation has been achieved by programming computers to perform sophisticated statistical analysis and modeling, develop marketing databases, increase the sophistication of their predictive models, or enhance their current processes with leading edge marketing tools such as data mining. While these efforts have helped reduce the negative impact of the changing marketing atmosphere, the industry has not been able to improve the average response rate to direct marketing.

A commonly-used marketing technique is called the RFM (Recency, Frequency and Monetary Value) technique. PCT International Application No. PCT/US908/22613, published as International Publication No. WO 99/22328 (incorporated fully herein by reference) discloses a computer-implemented targeted marketing system which evaluates many factors, including the RFM factors, to determine a customer list to be used for sending marketing materials in connection with a single proposed promotion event. The RFM technique is based on the theory that the customers that are most likely to respond to a proposed direct marketing event (e.g., a mailing of an offer) are those that have most recently been customers (Recency), and that have frequently been repeat customers (Frequency), and that have purchased significant dollar amounts (Monetary Value). Existing customers are scored based on their characteristics related to each of these three criteria, and a customer with a high RFM score is considered a good target for the proposed marketing event under analysis, i.e., they have a high propensity to respond in a positive way. Based on the RFM scores, a specialized customer list is generated for a single proposed marketing event.

Though the RFM technique achieves adequate results, since the focus is on only a single proposed marketing campaign at a time, a marketer may end up saturating its best customers with promotions, often sending out a subsequent and possibly redundant promotion before the previous marketing campaign has been allowed to generate it's maximum return-on-investment (ROI). Further, low RFM customers, which may represent a major growth opportunity for the marketer, may receive little or no attention.

The Applicant herein recognized the desirability of a marketing method and system which analyzed customer preferences, needs, and historical tendencies, which looked at an entire promotional plan comprising a set of at least two proposed promotion events and took into account the effects of a current promotion event on promotion events generated before, simultaneous with, and after the current promotion event. As a result, Applicant developed such a method and system which is described in U.S. Pat. No. 6,567,786 to Bibelnieks et al. (hereinafter “Bibelnieks”), incorporated fully herein by reference.

The method described and claimed in Bibelnieks operates well; however, due to the manner in which the problem is mathematically solved in Bibelnieks (using a linear program) it is necessary to solve for subsets of customers (as opposed to individuals) and on an irregular basis only (e.g., after at least several weeks have elapsed), since it would take large amounts of batch time to solve for a reasonably large portfolio of customers. Among other things, the method of Bibelnieks requires analysis over a “planning period”, which is a specific time period over which the predictive models are applied. As an example, as described in Bibelnieks, a planning period may cover an entire promotional plan or only a fraction thereof (e.g., a planning period may cover sixty days of a promotional plan spanning one year). As a result of having to perform the analysis over the planning period, the analysis is not up-to-date and does not take into account a successful customer contact that has just occurred.

Accordingly, it would be desirable to have a method and system for selecting an optimal set of events to be performed, for example, an optimal set of marketing events, that can be used to select the events making up the set in a efficient manner.

### SUMMARY OF THE INVENTION

The present invention takes a more focused approach to marketing and focuses not only on an individual customer (as opposed to a customer grouping) but also can look at occurrences on a shorter (e.g., daily) basis. The invention is a method for selecting an optimal set of events to be performed, where each event has a value, such as an expected gain, and where the selection of any event reduces or leaves unchanged the value of unselected events. The list of events is sorted, in full, once, based on the event values and then, on the occurrence of a predetermined trigger, the first event in the list is selected. Any changes to the unselected event values are effected, and then, rather than resorting the entire list of remaining events, the highest-valued unselected event is moved to the top without having to sort the entire list. This is accomplished by performing a lazy evaluation process that can evaluate without needing to resort the entire data set, e.g., a truncated sort that relies on the fact that all of the values in the list beneath the first value will be either reduced or remain the same, but will never get larger.

In a representative embodiment, the present invention comprises a method for selecting an optimal set of events to be performed, where each event has a value and where the selection of any event reduces or leaves unchanged the value of unselected events, comprising: sorting all unselected events into a pending event list, so that the events are ordered sequentially by their values, with the highest-valued event being at the top of the list; selecting the highest-valued unselected event upon the occurrence of a predetermined trigger; recomputing the values of each event after the selection of the highest-valued unselected event; and moving the highest-valued unselected event, after performance of the recomputing step, to the top of the list without performing a sort of the entire pending event list.

### BRIEF DESCRIPTION OF THE DRAWINGS

FIG. 1 illustrates how each of two customers are potential recipients of a promotional plan comprising promotional events E1-E7;

FIG. 2 illustrates a pivot table created given the data illustrated in FIG. 1;

FIG. 3 illustrates the creation of a table containing a “sort order” column which indicates the order of each customer/event combination;

FIG. 4 illustrates certain budgetary restrictions, or constraints;

FIG. 5 shows a degrading effect on the expected gain for the customer/event combinations illustrated in FIG. 3;

FIG. 6 illustrates how the entire data set has been resorted;

FIG. 7 illustrates how each of the items having expected gains higher than that of the item of interest are bumped up in the sort order; and

FIG. 8 is a flowchart illustrating the basic steps performed in connection with the present invention.

### DEFINITIONS

In this specification the following terms have the following meaning:

Promotional Event—a single promotion, for example, a specific mailing, catalog, or telemarketing campaign, focused on promoting particular products or services; also referred to as simply “Event” herein.

Promotional Plan—a specific set of at least two promotional events to be implemented at specific times over a period of time, e.g., monthly promotions to be mailed on the fifth day of each month for a twelve-month period or ten promotion events to be implemented on the same day. Generally a promotional plan will cover a relatively long period, such as one year. Also, a promotional plan in the context of the present invention is directed to a single prospective customer, and the promotion events making up the promotional plan can be related (e.g., all related to financial services or products) or can be unrelated (e.g., a catalog mailing for summer clothes, followed by a mailing of a catalog directed to the sale of firearms, followed by a catalog promotion directed to the sale of swimsuits, follows by a telemarketing campaign directed to the sale of financial services).

Unit Price—the total cost associated with a single item or “piece” of a promotional event within a promotional plan, i.e., if a promotional plan includes a promotional event that involves mailing an advertising piece, then each piece mailed has a cost equal to the unit price, which includes not only the cost of materials, but also infrastructure, labor, follow-up costs (e.g., costs of sending a representative to meet with a customer who has decided to make a purchase), and other related costs. Thus, a promotional event comprising a 3,000 piece mailing at a unit price X would cost 3000X. In the context of a telemarketing event, the unit price refers to the cost per call (again, including miscellaneous costs associated with the call center operations and any subsequent actions required to complete a sale).

Expected Gain—the expected marketing income that results from implementing a promotional event. Expected Gain is used to measure the expected financial benefit of a promotional event. The expected gain is determined by taking the average gross promotion revenues of promotional events of the type being proposed (from historical data and/or models) and subtracting the cost of the promotional event, and the cannibalization factor (described below) of the promotional event.

Cannibalization—the expected impact (expressed in percentage) on the expected gain of one promotional event due to the implementation of another promotional event. The concept of cannibalization is described in detail in Bibelnieks and is not further described herein.

Saturation—related to cannibalization; the act of over-contacting a customer or potential customer, i.e., overwhelming them with promotional pieces, marketing material, marketing information, etc.

### DETAILED DESCRIPTION OF THE PREFERRED EMBODIMENT

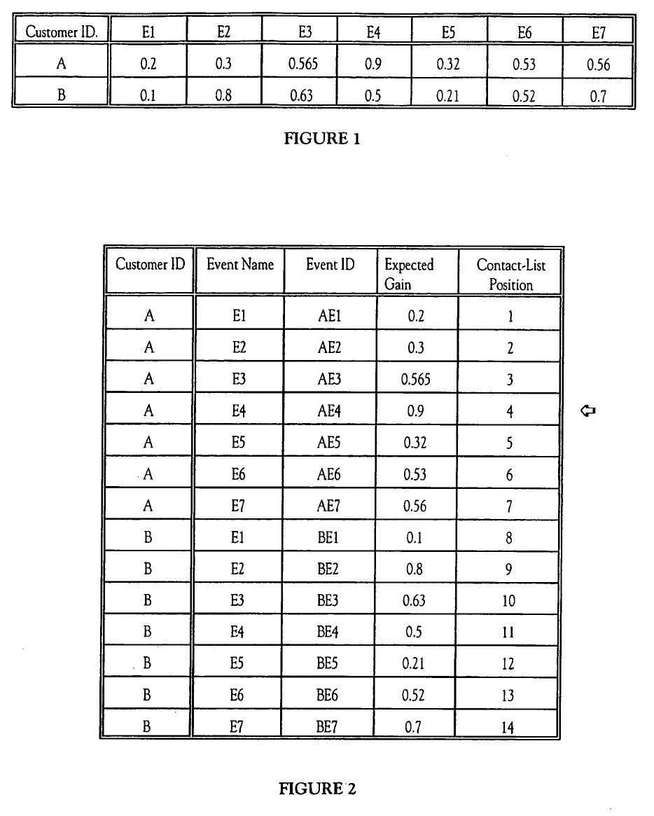

A simplified example explaining the present invention is now described with reference to FIGS. 1-6. In this example, two hypothetical customers, customer A and customer B, comprise the entire customer database to which the modified greedy heuristic of the present invention will be applied. It is understood that this example represents an extreme simplification and that in a real-world situation, there would typically be many thousands of customers and customer records in the database.

Referring to FIG. 1, each of the two customers of this example are potential recipients of a promotional plan comprising promotional events E1-E7. Promotional events E1-E7 could comprise, for example, a series of mailings promoting a certain item or category of items; a mixture of promotional pieces (mailings, phone calls, etc.) directed to similar items/services or diverse items/services; and the like.

For each customer, an expected gain in dollars for each promotional event with respect to each customer is given, e.g., for customer A, the expected gain for event E1 is $0.20, for event E2 is $0.30, for event E3 is $0.565, etc. These initial expected monetary gains are based on historical return data for similar promotional events and similar customers, and they are computed by taking the average expected gain for all customers (a dollar amount) and multiplying it by the propensity of each customer to respond, from a computer prediction model such as RFM. For the purpose of this example, it is assumed that promotional events E1-E7 are in chronological order, that is, event E1 occurs at time T+0, event E2 occurs at time T+1, event E3 occurs at time T+2, etc.

Given the data illustrated in FIG. 1, a pivot table is created, as shown in FIG. 2. Note that in creating the pivot table of FIG. 2, the chronological order of the promotional events of the promotional plan has not been changed; they are simply listed vertically, sorted first by customer then by event name, which corresponds to the chronological sequence of the promotional plan. For simplifying the following explanation, each individual promotional event is identified by an “event ID” comprising a combination of the customer ID and event name.

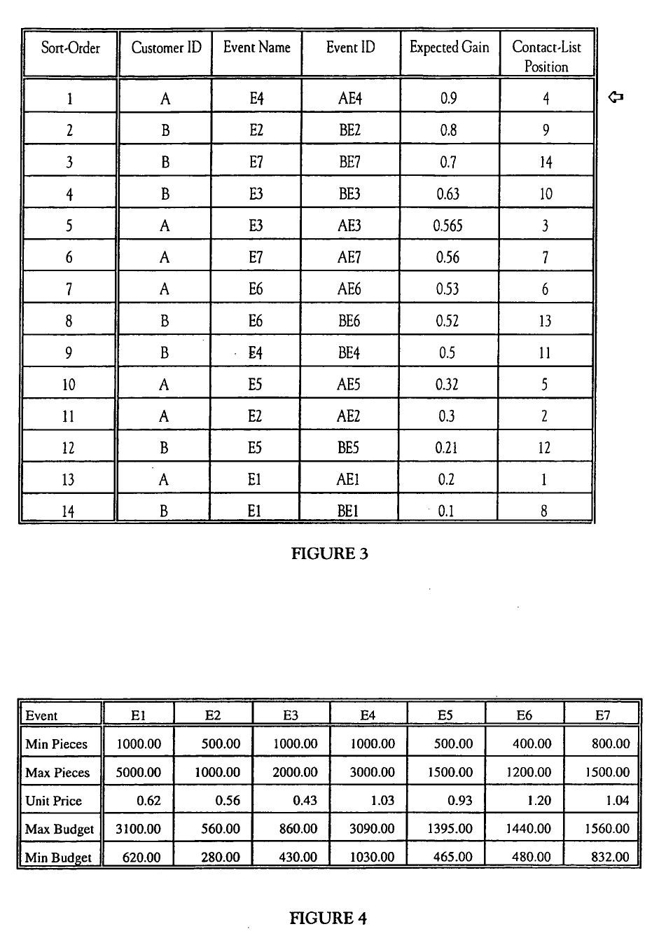

The next step is to rank the records in the pivot table of FIG. 2 by expected gain value. The actual table of FIG. 2 should not itself be sorted, because the order of the records in the database should remain undisturbed so that each chronological record can be easily located. However, a copy of the pivot table of FIG. 2 can be sorted by expected gain value, resulting in the creation of the table of FIG. 3. Alternatively, a sort index can be prepared, equivalent to the “contact-list position” column of FIG. 3 which identifies which row of FIG. 2 contains the highest expected gain (contact-list position 4, indicated by an arrow), the next highest (contact-list position 9), etc. This step optimizes the list of contacts globally, that is, independent of any one individual or any particular promotional event. The event or events that create the best “global” expected gain will be at the top of the list and the expected gains will become sequentially less from top to bottom.

As shown in FIG. 3, a “sort order” column (i.e., a rank table) indicates the order of each customer/event combination after the creation of the table of FIG. 3 (which shows the data from FIG. 2 sorted by the expected gain). The sort of FIG. 3 forms a second table (a primary sort-list), i.e., as noted above, the sorting does not change the position of each customer/event combination in the database, as indicated by the column “contact-list position” in FIG. 3. For example, the first item in the sort order of FIG. 3 corresponds to event ID AE4, and is placed at the top of the list in FIG. 3 because its expected gain, 0.9, is the highest of all of the customer/event combinations. Looking at FIG. 2, it can be seen that event ID AE4 is situated in the contact-list position 4, and FIG. 3 indicates same in the contact-list position column. The same holds true for each row of FIG. 3.

Each event has certain budgetary restrictions, otherwise known as constraints. These constraints are illustrated in FIG. 4. For example, event E1 has a minimum number of pieces (e.g., mailings, advertisements, etc.) of 1,000 and a maximum number of 5,000, at a unit price of 0.62 cents per unit. Thus, this results in a minimum budget of $620 and a maximum budget of $3,100. Similar constraints are illustrated for the remaining events E2, E3, E4, E5, E6, and E7. The number of pieces are typically decided by “print run cut-offs” that is, the printing trade price-per-piece based on economic cut-offs, which factor the size of the printing equipment, the cost of set-up, etc. Typically, the more being printed, the less expensive per unit it is to print. In the example of a call center operation, rather than a printed publication operation, the cut-offs do exist, but are predicated on the number of operators capable of making outbound calls or sending outbound emails, or having the right skill to introduce that type of event, etc. There may be 100 operators, but only ten are specialized in selling mortgage products, for example. For each event, there is a minimum and maximum (lower and upper bound, respectively) on the number of event “pieces” and the cost budgets are based upon the monetary amount it takes to execute each event. This yields a maximum budget (as well as a minimum budget) as shown.

Adding together all of the maximum budget values, the maximum “global budget” can be computed, that is, the maximum amount that can be spent for events E1-E7, combined. In a typical scenario, the goal would be to spend an amount that lies between the maximum and minimum budget values.

In accordance with the present invention, the sort order illustrated in FIG. 3 indicates which event ID should be analyzed first. The analysis typically starts upon the occurrence of some triggering event, i.e., some action that changes one or more data values (for example, if a particular customer makes a purchase of an item being “pushed” in an event; if a particular customer dies; etc.). Alternatively, the triggering event can be simply elapsed time, that is, the analysis could be performed every night at a particular time, every week, etc.

When the analysis begins, each customer/event combination is analyzed, in order of highest expected gain to lowest expected gain, until the various “budgetary” restraints have been met (these budgetary restraints can be measured in various terms, i.e., a budgetary restraint can refer to dollars spent, but can also refer to, for example, a number of possible occurrences, e.g., a set number of outbound calls made by a call center). For example, if a global budget is met, the analysis is complete. If an individual budget for a particular customer is met, that customer is no longer considered in the remaining analysis. Similarly, if a particular event has a budget that is met, any customer/event combinations involving that event are disregarded when/if their turn for analysis arrives, as the meeting of a budget signals the termination of that particular item for further consideration.

In accordance with the present invention, the first customer/event combination in the sort (corresponding in this example to the event identified by event ID AE4) is processed. First, the event ID is designated in some manner to indicate that it has been analyzed, e.g., by putting a minus sign in front of the event ID (so that event ID AE4 would now be −AE4) or by any known means of designating, to the processor, that this item has been (or is currently being) allocated. The global budget is reduced by $1.03 (representing a single unit for customer A with respect to event E4), and the individual budget for customer A is also reduced by $1.03. Similarly, the budget for event E4 is reduced by one unit.

Instead of going directly to the next item in the sort list, first, in accordance with the present invention, the impact of performing event E4 with respect to customer A, on the remaining unchecked or unallocated potential customer/event combinations, is determined. This is done, for example, using the cannibalization analysis and saturation analysis techniques described in the Bibelnieks patent. This degrades the expected gain for events E1-E3 and E5-E7 with respect to customer A, i.e., the saturative effect of events 4 vs. 1, 4 vs. 2, 4 vs. 3, 4 vs. 5, 4 vs. 6, and 4 vs. 7 are applied to customer A's expected gains. For example, if it is assumed that customer A has purchased a product or service that is the subject of promotional events E1-E7, this will have an impact on the expected gain for the remaining events directed to customer A (a purchase by customer A will typically have no impact on the expected gain of events directed to customer B).

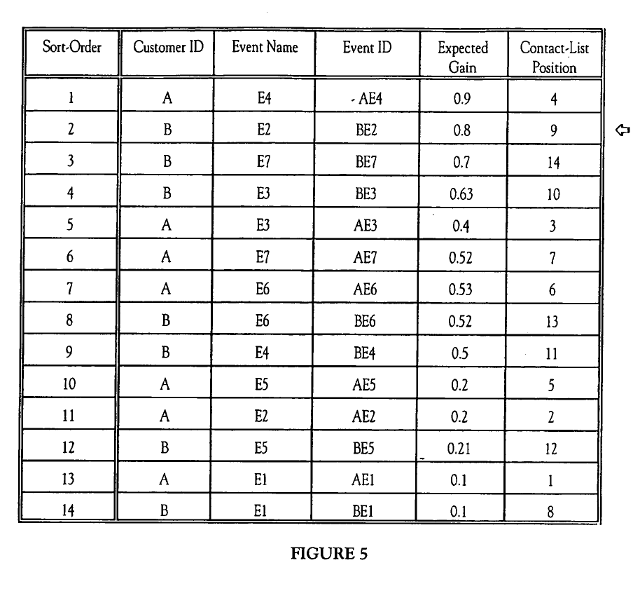

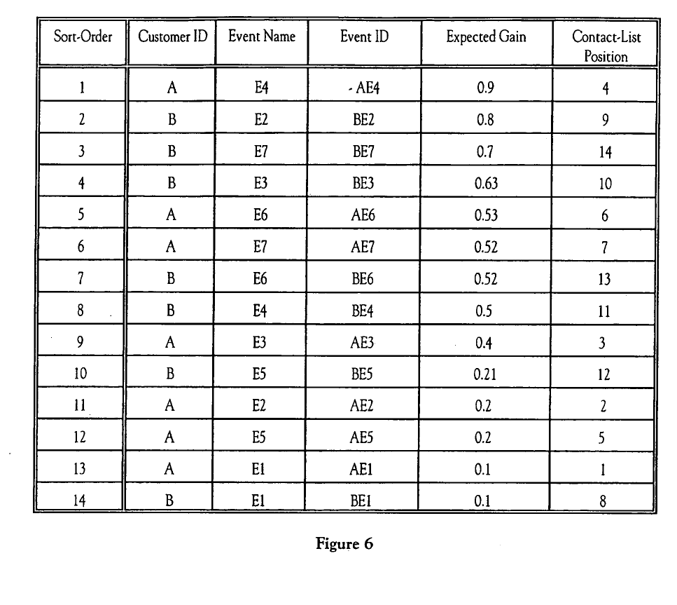

By performing the cannibalization/saturation process, the expected gain for all other events for the affected customer is reduced (e.g., typically events close in time have reduced expected gains) or remains the same (e.g., if an event is far removed in time from “target” event identified by event ID AE4, event AE4 may have no saturative effect on it). FIG. 5 shows a degrading effect on the expected gain for the customer/event combinations illustrated in FIG. 3 (it is noted that, for the purpose of example only, the expected gain values shown in FIG. 5 were changed arbitrarily and were not actually subjected to the saturation analysis of Bibelnieks). In looking at the expected gain column, it is noted that, once the saturative effect of the event associated with event ID AE4 is calculated with respect to the remaining customer/event combinations, the sort is potentially out of sequence (e.g., note that event ID AE3 now has an expected gain of 0.4, while event ID AE6 has a higher expected gain of 0.53); however, since the sort of FIG. 5 is based on the expected gains illustrated in FIG. 3, they could be resorted (or the sort index can be reordered), resulting in the sort of FIG. 6. As can be seen, comparing the contact-list position of FIG. 3 with the contact-list position of FIG. 6, while certain of the elements maintain their same position, others have changed. Note further that, as would be expected, the performance of the event identified by event name AE4 has no impact on the expected gain of events directed to Customer B.

While resorting the entire data set as shown in FIG. 6 will result in a reordering of the sort by expected gain, and thus identify the next highest expected gain while factoring in the saturation effect of a previous event, when there are thousands of records to deal with, sorting after each event is extremely time-consuming and costly in terms of processing power. The present invention solves this problem by performing a “truncated bubble sort” (or other sorting methods that do not require complete sorting of all of the data) on the data illustrated in FIG. 5, so that the complete re-sort of the data as shown in FIG. 6 is unnecessary. It is called a “truncated” bubble sort because, unlike a traditional bubble sort where the entire data set is subjected to bubble sorting, as described below and in accordance with the present invention, the bubble sorting process is stopped whenever a data value following a data value of interest is smaller than or equal to the data value of interest, since the saturation/cannibalization process can only depress (lower) expected gain values of events yet to be considered.

Referring back to FIG. 5, in accordance with the present invention, the first item in the sort order is marked as having been processed (e.g., using a minus sign as shown in FIG. 5). Next, the expected gain of the next item in the list (called the “item of interest”, identified by an arrow in FIG. 5), corresponding to event ID BE2, is compared with the next item following it in the list (called the “subsequent item”), corresponding to event ID BE7. If the item of interest is larger than the subsequent item, then the bubble sort process stops, and the item of interest (event ID BE2) is analyzed. Just as with event ID AE4, event ID BE2 is designated as having been used, e.g., by putting a minus sign in front of the event ID, the global budget is reduced by the unit price of event E2 ($0.56), and then the individual budget for customer B is also reduced by $0.56. Similarly, the budget for event E2 is reduced by one unit.

Then, as was done with event ID AE4, the impact of performing event E2 with respect to customer A, on the remaining potential customer/event combinations, is determined. In other words, the saturation process is performed to determine the impact on the expected gains of events (2 vs. 1, 2 vs. 3, 2 vs. 4, 2 vs. 5, 2 vs. 6, and 2 vs. 7). Once the new values are determined, the next item in the expected gain column of FIG. 5, item 3 in the sort order (corresponding to event ID BE7) is processed, saturation is calculated as above, and then the truncated bubble sort is performed on the remaining expected gains after saturation. As long as the gain of the next item of interest is larger than that of the subsequent item in the truncated bubble sort order, the process proceeds as above.

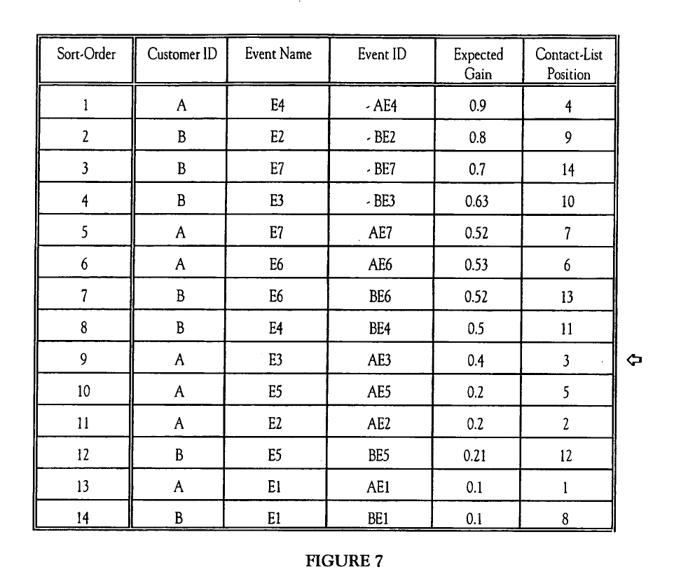

However, if the gain of the item of interest is less than that of the subsequent item during the truncated bubble sort, the sort order is changed. More specifically, if, after saturation, a comparison between the expected gain of the next item of interest in the sort order and the subsequent item results in a determination that the expected gain of the item of interest is less than the expected gain of the subsequent item, then their positions in the sort order are swapped. For example, in FIG. 5, item 5 in the sort-order column (event ID AE3) has an expected gain of 0.4, which is less than the expected gain of subsequent sort-order item 6 (event ID AE7), which has an expected gain of 0.52. Thus, if it is assumed that items 1-4 of FIG. 5 have already been analyzed, then the event occupying sort-order position 5 of FIG. 5 (event ID AE3) becomes the item of interest for the next iteration, and after performing the truncated bubble sort of the present invention, a new table as illustrated in FIG. 7 is formed.

As shown in FIG. 7, each of the items having expected gains higher than that of the item of interest (event AE3) are bumped up in the sort order. Item 5 is switched with item 6 to move the higher expected gain of item 6 up above the lower expected gain of item 5, and then the item of interest (now the sixth item in the list) is compared with the next subsequent item (the seventh item in the list). This continues until a point is reached where the expected gain of the subsequent item is the same as or less than the item of interest. In the sample data set of FIG. 5, sort-order item 5 will move all the way down to sort-order item 9, bumping each of items 6-9 up to positions 5-8, respectively. Once this occurs the process designates the next unanalyzed item at the top of the list (current item 5 of FIG. 7) for analysis, and the process continues.

This “lazy evaluation” process quickens processing and makes more efficient use of available resources. Since it is known that the saturation/cannibalization process can only reduce (or keep the same) the expected gain values for the affected customer and since the values are being analyzed from highest-to-lowest expected gain values, it is known that, with respect to the customer under analysis, all gain values following will be less than (or the same as) the gain value of interest. Thus, there is no need to perform the bubble sort on the entire data set; instead, the sort only needs to proceed to a point where the item of interest has a higher value than the next item in the list. This substantially reduces the processing time required to perform the desired analysis. As noted above, other lazy evaluation techniques can be used, e.g., a binary chop sorting process using a binary chop algorithm.

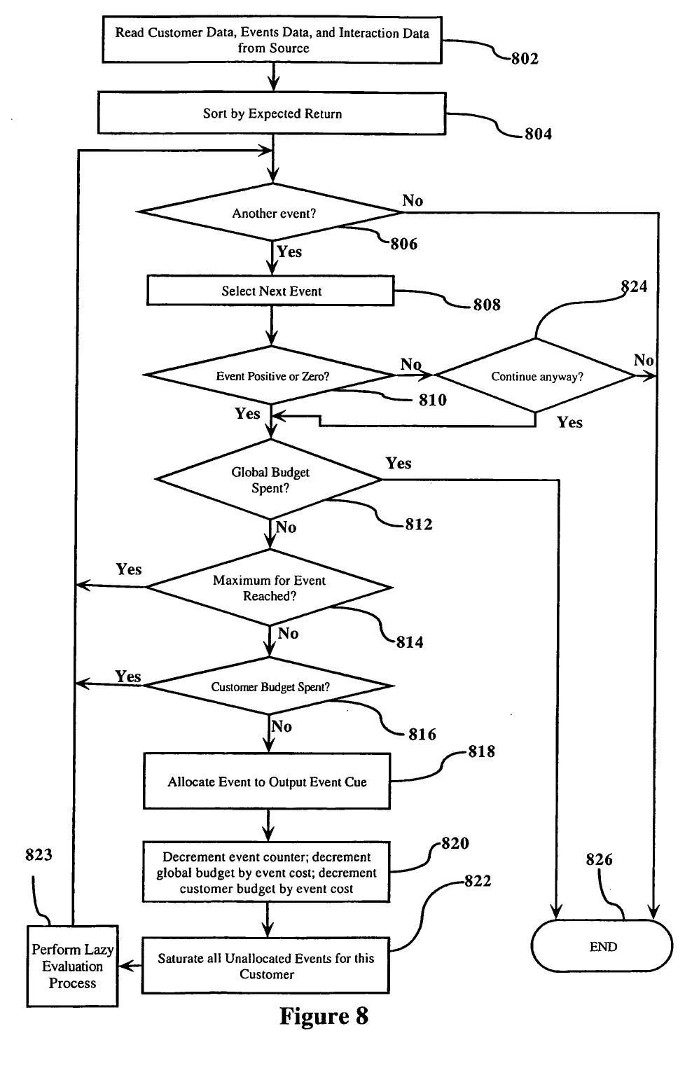

FIG. 8 is a flowchart illustrating basic steps performed in connection with the present invention. Referring to FIG. 8, at step 802, customer data, events data, and interaction data (data from a saturation/cannibalization matrix as described in Bibelnieks) is read from a source (e.g., the database). At step 804, the data is sorted by expected return, yielding a table such as FIG. 3. At step 806, a determination is made as to whether or not there are any items to be processed. Typically, there will be items to process if an event has occurred that will lower the expected gain for one or more of the other events, e.g., one of the targeted customers purchases an item that is the subject of the events in the promotional plan. If no, the process proceeds to step 826 and ends. If there are items to be processed, the next item is selected at step 808. This involves selecting the first item in the sort order column—the item of interest—which will also be the item with the highest expected gain. At step 810, a determination is made as to whether or not the expected gain of the item of interest is either positive or zero. If the expected gain is negative, this is an indication that performing the event associated with the item is unlikely to make any money for the entity running the advertising campaigns. If it is determined that the event associated with the item has a negative gain, the process proceeds to step 824 where a determination is made as to whether or not to continue the process anyway. As an example, it might be desirable to run a promotional act anyway, just to keep advertising materials in front of the potential customers, e.g., for name exposure. If at step 824 it is determined not to continue, the process proceeds to step 826 where the process ends. If, however, it is determined to continue anyway, the process proceeds to step 812.

The process proceeds directly to step 812 if a determination is made at step 810 that the expected gain of the event associated with the item of interest is positive or zero. At step 812, a determination is made as to whether or not the global budget has been spent. If all the budget money designated for all of the events has been spent, the process ceases at step 826. If, however, the global budget has not been reached, then the process proceeds to step 814, where a determination is made as to whether or not the maximum number of pieces has been reached for the event associated with the item of interest. For example, if the event has a maximum number of pieces of 1,000, and at step 814 a determination is made that these numbers have been reached, the process reverts back to step 806 to process the next item.

If, however, at step 814 it is determined the maximum number of pieces has not been reached for the event associated with the item of interest, then the process proceeds to step 816 to determine if the customer budget has been reached for the customer associated with the item of interest. If the customer budget has been reached, the process proceeds back to step 806 to process the next item. If, however, the customer budget has not been spent, then the process proceeds to step 818, where the item is allocated to the output event queue. This just means that the event is going to be processed as planned, i.e., the advertising or promotional event will occur (e.g., the mailing, telephone call, etc.). At step 820, an event counter is decremented, the global budget is decremented, and the customer budget is decremented. These counters allow the determinations to be made as to whether or not the number of events has been reached, the maximum number of budget monies overall (globally) have been reached, and the maximum budget for the customer has been reached.

At step 822, all unallocated events for this customer are subjected to the saturation process as described above, the data is subjected to the above-described truncated bubble sort (step 823), and the process proceeds back to step 806 to process the next item, if any.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage; for example, in a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A method for selecting an optimal set of events to be performed, where each event has a value and where the selection of any event reduces or leaves unchanged the value of unselected events, comprising:
performing a first sort on all unselected events to form a pending event list, so that the events are ordered sequentially by their values, with the highest-valued event being at the top of the pending event list;
selecting the highest-valued unselected event upon the occurrence of a predetermined trigger;
recomputing the values of each event after the selection of the highest-valued unselected event; and
moving the highest-valued unselected event, after performance of the recomputing step, to the top of the pending event list without performing a second sort of the entire pending event list.

2. The method of claim 1, whereby the selecting, recomputing, and moving steps are iteratively performed until the occurrence of a predetermined condition.

3. The method of claim 2, whereby said predetermined condition comprises the selection of a predetermined number of events.

4. The method of claim 2, wherein each event has a cost associated with its selection, whereby said predetermined condition comprises the reaching of a predetermined cost total for said selected events.

5. The method of claim 2, wherein said moving step comprises the performance of a truncated bubble sort on the events based on their recomputed values.

6. The method of claim 2, wherein said moving step comprises the performance of a binary chop sorting process on the events based on their recomputed values.

7. The method of claim 1, wherein the value of each event comprises its each events expected gain.

8. The method of claim 7, wherein said recomputing process comprises performing a saturation process on said unselected events.

9. A system for selecting an optimal set of events to be performed, where each event has a value and where the selection of any event reduces or leaves unchanged the value of unselected events, comprising:
means for performing a first sort on all unselected events to form a pending event list, so that the events are ordered sequentially by their values, with the highest-valued event being at the top of the pending event list;
means for selecting the highest-valued unselected event upon the occurrence of a predetermined trigger;
means for recomputing the values of each event after the selection of the highest-valued unselected event; and
means for moving the highest-valued unselected event, after performance of the recomputing step, to the top of the pending event list without performing a second sort of the entire pending event list.

10. The system of claim 9, whereby the selecting, recomputing, and moving means perform their functions iteratively until the occurrence of a predetermined condition.

11. The system of claim 10, whereby said predetermined condition comprises the selection of a predetermined number of events.

12. The system of claim 10, wherein each event has a cost associated with its selection, whereby said predetermined condition comprises the reaching of a predetermined cost total for said selected events.

13. The system of claim 10, wherein said moving means includes means for performaning a truncated bubble sort on the events based on their recomputed values.

14. The system of claim 10, wherein said moving means includes means for performing a binary chop sorting process on the events based on their recomputed values.

15. The system of claim 9, wherein the value of each event comprises its each events expected gain.

16. The system of claim 15, wherein said recomputing means includes means for performing a saturation process on said unselected events.

17. A computer program product for selecting an optimal set of events to be performed, where each event has a value and where the selection of any event reduces or leaves unchanged the value of unselected events, the computer program product comprising a computer-readable storage medium having computer-readable program code embodied in the medium, the computer-readable program code comprising:
computer-readable program code that performs a first sort on all unselected events to form a pending event list, so that the events are ordered sequentially by their values, with the highest-valued event being at the top of the pending event list;
computer-readable program code that selects the highest-valued unselected event upon the occurrence of a predetermined trigger;
computer-readable program code that recomputes the values of each event after the selection of the highest-valued unselected event; and
computer-readable program code that moves the highest-valued unselected event, after performance of the recomputing step, to the top of the pending event list without performing a second sort of the entire pending event list.

18. The computer program product of claim 17, whereby the computer-readable program code for selecting, recomputing, and moving perform their functions iteratively until the occurrence of a predetermined condition.

19. The computer program product of claim 18, whereby said predetermined condition comprises the selection of a predetermined number of events.

20. The computer program product of claim 18, wherein each event has a cost associated with its selection, whereby said predetermined condition comprises the reaching of a predetermined cost total for said selected events.

21. The computer program product of claim 18, wherein said computer-readable program code for moving comprises computer-readable program code for performing a truncated bubble sort on the events based on their recomputed values.

22. The computer program product of claim 18, wherein said computer-readable program code for moving comprises computer-readable program code for performing a binary chop sorting process on the events based on their recomputed values.

23. The computer program product of claim 17, wherein the value of each event comprises its each events expected gain.

24. The computer program product of claim 7, wherein said computer-readable program code for recomputing comprises computer-readable program code for performing a saturation process on said unselected events.
